(19) United States
(12) Patent Application Publication
(10) Pub. No.: US 2026/0217742 A1
(43) Pub. Date: Jul. 30, 2026

(54) COMPOUNDS AND PROCESSES FOR EXTREME ULTRAVIOLET LITHOGRAPHY

(71) Applicant: ENTEGRIS, INC., Billerica, MA (US)

(72) Inventors: David M. Ermert, Danbury, CT (US); Thomas M. Cameron, Newtown, CT (US)

(21) Appl. No.: 19/574,135

(22) Filed: Mar. 20, 2026

Related U.S. Application Data
(62) Division of application No. 18/216,395, filed on Jun. 29, 2023, now Pat. No. 12,612,423.
(60) Provisional application No. 63/357,771, filed on Jul. 1, 2022.

(51) Int. Cl. C07F 7/22

(52) U.S. Cl. CPC C07F 7/2284; C07F 7/2224

(57) ABSTRACT

The present disclosure includes the preparation of mixed-ligand compounds, such as tin(II) cyclopentadienylide complexes. The compounds of the present disclosure can be used as atomic layer deposition (ALD) precursors for extreme ultraviolet (EUV) lithography. The compounds of the present disclosure can also be used as plasma chemical vapor deposition (CVD) precursors for EUV lithography.

### PRIORITY CLAIM

The present disclosure is a divisional of U.S. patent application Ser. No. 18/216,395 filed Jun. 29, 2023, which claims priority to U.S. provisional patent application No. 63/357,771 with a title of “COMPOUNDS AND PROCESSES FOR EXTREME ULTRAVIOLET LITHOGRAPHY” and a filing date of Jul. 1, 2022, each of which documents are incorporated by reference herein.

### FIELD

The present disclosure relates to the field of compounds and processes for extreme ultraviolet (EUV) lithography.

### BACKGROUND

Extreme ultraviolet lithography is an optical lithography technology using a range of extreme ultraviolet wavelengths to produce a pattern by exposing reflective photomask to UV light which gets reflected onto a substrate covered by photoresist.

### SUMMARY

The present disclosure includes the preparation of mixed-ligand compounds, such as tin(II) cyclopentadienylide complexes. The compounds of the present disclosure can be used as precursors, e.g., atomic layer deposition (ALD) precursors or plasma chemical vapor deposition (CVD) precursors for EUV lithography. For example, the compounds of the present disclosure can be used for EUV hard mask applications. The tin compounds can be used in other applications as well (e.g., polyvinyl chloride (PVC) stabilizers, biocides, precursors for tin(IV) oxide coatings, and catalysts for organic transformations).

In some embodiments, the present disclosure includes a cyclopentadienylide tin(II) compound of formula (I) comprising:

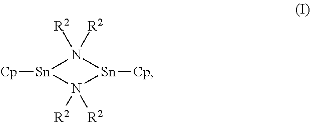

wherein each R² is independently hydrogen, a C₁-C₄, or a halide containing C₁-C₄,
wherein

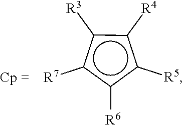

and
wherein R³-R⁷ is hydrogen or C₁-C₄.

In some embodiments, the present disclosure includes wherein each R² is independently a methyl, ethyl, propyl, isopropyl, n-butyl, isobutyl, t-butyl, or sec-butyl group.

In some embodiments, the present disclosure includes wherein each R² is a methyl group.

In some embodiments, the present disclosure includes wherein each R² is a C₁-C₄ alkyl group.

In some embodiments, the present disclosure includes wherein the C₁-C₄ is branched or unbranched.

In some embodiments, the present disclosure includes wherein the C₁-C₄ is substituted or unsubstituted.

In some embodiments, the present disclosure includes wherein each R³-R⁷ is hydrogen.

In some embodiments, the present disclosure includes wherein each R² is hydrogen and each R³-R⁷ is hydrogen.

In some embodiments, the present disclosure includes a method of forming a cyclopentadienylide tin(II) compound of formula (I):

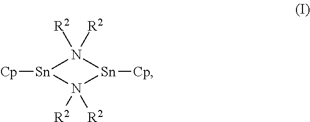

wherein each R² is independently hydrogen, a C₁-C₄, or a halide containing C₁-C₄ group,
wherein

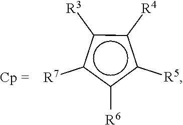

wherein R³-R⁷ is hydrogen or C₁-C₄, and
wherein the method comprises: contacting [Sn(N(R²)₂)₂]₂ with Cp₂Sn or CpH.

In some embodiments, the present disclosure includes wherein [Sn(N(R²)₂)₂]₂ is dissolved in tetrahydrofuran before the contacting step.

In some embodiments, the present disclosure includes wherein R² is independently a methyl, ethyl, propyl, isopropyl, n-butyl, isobutyl, t-butyl, or sec-butyl group.

In some embodiments, the present disclosure includes wherein Cp₂Sn or CpH is dissolved in tetrahydrofuran before the contacting step.

In some embodiments, the present disclosure includes a cyclopentadienylide tin(II) compound of formula (II):

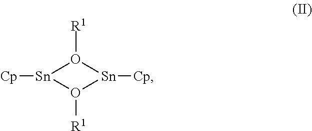

wherein each R¹ is independently hydrogen, C₁-C₄, or a halide containing C₁-C₄, and
wherein

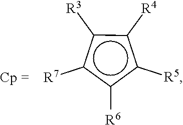

and
wherein R³-R⁷ is hydrogen or C₁-C₄.

In some embodiments, the present disclosure includes wherein each R¹ is independently a methyl, ethyl, propyl, isopropyl, n-butyl, isobutyl, t-butyl, or sec-butyl group.

In some embodiments, the present disclosure includes wherein each R¹ is a methyl group.

In some embodiments, the present disclosure includes wherein each R¹ is a C₁-C₄ alkyl group.

In some embodiments, the present disclosure includes wherein the C₁-C₄ is branched or unbranched.

In some embodiments, the present disclosure includes wherein the C₁-C₄ is substituted or unsubstituted.

In some embodiments, the present disclosure includes wherein each R³-R⁷ is hydrogen.

In some embodiments, the present disclosure includes wherein each R¹ is hydrogen and each R³-R⁷ is hydrogen.

In some embodiments, the present disclosure includes a method of forming a cyclopentadienylide tin(II) compound of formula (II):

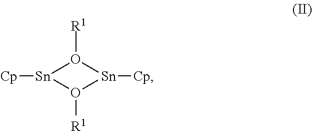

wherein each R¹ is independently hydrogen, a C₁-C₄, or a halide containing C₁-C₄ group,
wherein

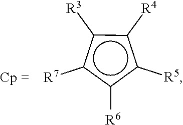

wherein R³-R⁷ is hydrogen or C₁-C₄, and wherein the method comprises: contacting [Sn(O(R¹))₂]₂ with Cp₂Sn.

In some embodiments, the present disclosure includes wherein [Sn(O(R¹))₂]₂ is dissolved in tetrahydrofuran before the contacting step.

In some embodiments, the present disclosure includes wherein R¹ is independently a methyl, ethyl, propyl, isopropyl, n-butyl, isobutyl, t-butyl, or sec-butyl group.

In some embodiments, the present disclosure includes wherein Cp₂Sn is dissolved in tetrahydrofuran before the contacting step.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts a non-limiting embodiment of a method 100 for the synthesis of cyclopentadienylide tin(II) amides described herein.

FIG. 2 depicts a non-limiting embodiment of a method 200 for the synthesis of cyclopentadienylide tin(II) alkoxides described herein.

FIG. 3 depicts a non-limiting example of a method 300 for the synthesis of cyclopentadienyl tin(II) amides using Cp₂Sn described herein.

FIG. 4 depicts a solid-state structure of [CpSn(N(CH₃)₂)]₂ as determined by X-ray crystallographic analysis.

FIG. 5 depicts a non-limiting example of a method 600 for the synthesis of cyclopentadienyl tin(II) amides using CpH described herein.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The present disclosure relates to compounds of, including the preparation of, mixed-ligand compounds. The mixed-ligand compounds include tin(II) cyclopentadienylide complexes including cyclopentadienylide amides and cyclopentadienylide alkoxides. The compounds of the present disclosure can be used as atomic layer deposition (ALD) precursors for EUV lithography. For example, the compounds of the present disclosure can be used for EUV hard mask applications. The tin compounds can be used in other applications as well (e.g., polyvinyl chloride (PVC) stabilizers, biocides, precursors for tin(IV) oxide coatings, and catalysts for organic transformations).

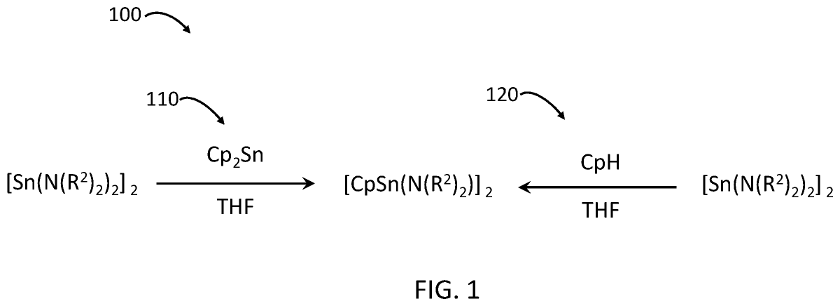

FIG. 1 depicts a non-limiting embodiment of a method 100 for the synthesis of cyclopentadienylide tin(II) amides described herein. In some embodiments, the present disclosure includes contacting [Sn(N(R²)₂)₂]₂ with Cp₂Sn 110 or CpH 120. In some embodiments, the method 100 includes dissolving [Sn(N(R²)₂)₂]₂ in tetrahydrofuran (THF) before the contacting step. In some embodiments, the method 100 includes dissolving Cp₂Sn or CpH in tetrahydrofuran (THF) before the contacting step.

In some embodiments, using Cp₂Sn 110 in the method 100 can include loading [Sn(N(R²)₂)₂]₂ into a container (e.g., a vial) and dissolving in tetrahydrofuran (THF). In a separate container, Cp₂Sn can be added and dissolved in tetrahydrofuran (THF). The solution with [Sn(N(R²)₂)₂]₂ dissolved in THF can then be added to the solution with Cp₂Sn dissolved in THF. The combined solution of [Sn(N(R²)₂)₂]₂, Cp₂Sn, and tetrahydrofuran (THF) can be stirred for a period of time. The combined solution can be stirred for an extended period of time, e.g., between one to twelve hours. For example, the combined solution can be stirred for greater than one hour, greater than three hours, greater than six hours, greater than nine hours, less than twelve hours, less than nine hours, less than six hours, or less than three hours. After stirring the combined solution, the combined solution can then be dried. In some examples, the combined solution can be dried under reduced pressure to yield a solid mass. The reduced pressure can be selected from a range of reduced pressures, e.g., 100 mTorr-760 Torr (atm). For example, the reduced pressure can be greater than 100 mTorr, greater than 1 torr, greater than 10 torr, greater than 100 torr, greater than 300 torr, greater than 500 torr, greater than 700 torr, less than 760 torr, less than 700 torr, less than 500 torr, less than 300 torr, less than 100 torr, less than 10 torr, or less than 1 torr. In some examples, the stirred solution can be dried under dynamic vacuum, including at the reduced pressure values described herein. X-ray quality crystals can be grown by slow evaporation of a solution, such as a NMR solvent, including a concentrated benzene (C₆D₆) solution, Tetrahydrofuran (THF), diethyl ether (Et₂O), or toluene (PhMe).

In some embodiments, using CpH 120 in the method 100 can include diluting cyclopentadiene with tetrahydrofuran (THF). The solution of cyclopentadiene with tetrahydrofuran (THF) can then be added to a stirred solution of THF and [Sn(N(R²)₂)₂]₂. The combined solution of [Sn(N(R²)₂)₂]₂, CpH, and tetrahydrofuran (THF) can be stirred for a period of time. The combined solution can be stirred for an extended period of time, e.g., between one to twelve hours. For example, the combined solution can be stirred for greater than one hour, greater than three hours, greater than six hours, greater than nine hours, less than twelve hours, less than nine hours, less than six hours, or less than three hours. After stirring the combined solution, the combined solution can then be dried. In some examples, the stirred solution can be dried under reduced pressure to yield a solid mass. For example, the reduced pressure can be greater than 100 mTorr, greater than 1 torr, greater than 10 torr, greater than 100 torr, greater than 300 torr, greater than 500 torr, greater than 700 torr, less than 760 torr, less than 700 torr, less than 500 torr, less than 300 torr, less than 100 torr, less than 10 torr, or less than 1 torr. In some examples, the stirred solution can be dried under dynamic vacuum, including at the reduced pressure values described herein.

In some embodiments, using Cp₂Sn 110 or CpH 120 in the method 100 of the present disclosure includes a cyclopentadienylide tin(II) compound of formula (I):

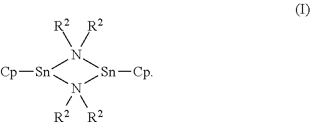

In some embodiments, each R² is independently hydrogen or C₁-C₄.

In some embodiments, each R² is independently a methyl, ethyl, propyl, isopropyl, n-butyl, isobutyl, t-butyl, or sec-butyl group. In some embodiments, each R² is a methyl group. In some embodiments, each R² is a C₁-C₄ alkyl group.

In some embodiments, the cyclopentadienylide (Cp) has the formula (1):

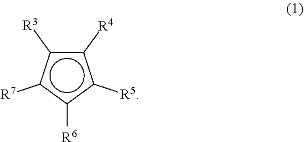

In some embodiments, R³-R⁷ is hydrogen or C₁-C₄. In some embodiments, each R³-R⁷ is independently a methyl, ethyl, propyl, isopropyl, n-butyl, isobutyl, t-butyl, or sec-butyl group. In some embodiments, each R² is a methyl group.

In some embodiments, the C₁-C₄ is branched or unbranched. In some embodiments, the C₁-C₄ is substituted or unsubstituted.

In some embodiments, each R² is a methyl group and each R³-R⁷ is hydrogen. In some embodiments, each R² is hydrogen and each R³-R⁷ is hydrogen.

In some embodiments, the present disclosure includes forming a cyclopentadienylide tin(II) compound of formula (I). In some embodiments, each R² is independently hydrogen, a C₁-C₄, or a halide containing C₁-C₄ group.

In some embodiments, the cyclopentadienylide (Cp) has the formula (1). In some embodiments, R³-R⁷ is hydrogen or C₁-C₄. In some embodiments, the method 100 includes forming a cyclopentadienylide tin(II) compound of formula (I) by contacting [Sn(N(R²)₂)₂]₂ with Cp₂Sn or CpH. In some embodiments, the method 100 includes dissolving [Sn(N(R²)₂)₂]₂ in tetrahydrofuran (THF) before the contacting step. In some embodiments, the method 100 includes dissolving Cp₂Sn or CpH in tetrahydrofuran (THF) before the contacting step.

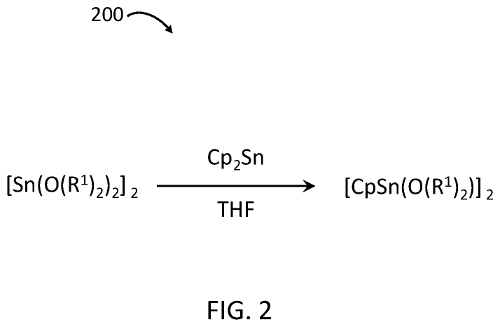

FIG. 2 depicts a non-limiting embodiment of a method 200 for the synthesis of cyclopentadienylide tin(II) alkoxides described herein. In some embodiments, the present disclosure includes contacting [Sn(O(R¹))₂]₂ with Cp₂Sn. In some embodiments, the method 200 includes dissolving [Sn(O(R¹))₂]₂ in tetrahydrofuran (THF) before the contacting step. In some embodiments, the method 200 includes dissolving Cp₂Sn in tetrahydrofuran (THF) before the contacting step.

In some embodiments, using Cp₂Sn in the method 200 of the present disclosure includes a cyclopentadienylide tin(II) compound of formula (II):

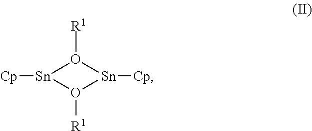

In some embodiments, each R¹ is independently hydrogen, a C₁-C₄, or a halide containing C₁-C₄.

In some embodiments, each R¹ is independently a methyl, ethyl, propyl, isopropyl, n-butyl, isobutyl, t-butyl, or sec-butyl group. In some embodiments, each R¹ is a methyl group. In some embodiments, each R¹ is a C₁-C₄ alkyl group. In some embodiments, each R¹ is a C₁-C₄ alkyl group that contains at least one halide (e.g., fluorine (F), chlorine (CI), bromine (Br), or iodine (1)). For example, R¹ can be —OCH₂CF₃ (trifluoro ethoxide).

In some embodiments, the cyclopentadienylide (Cp) has the formula (1):

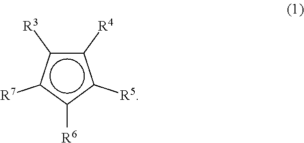

In some embodiments, R³-R⁷ is hydrogen or C₁-C₄. In some embodiments, each R³-R⁷ is independently a methyl, ethyl, propyl, isopropyl, n-butyl, isobutyl, t-butyl, or sec-butyl group. In some embodiments, each R¹ is a methyl group.

In some embodiments, the C₁-C₄ is branched or unbranched. In some embodiments, the C₁-C₄ is substituted or unsubstituted.

In some embodiments, each R¹ is a methyl group and each R³-R⁷ is hydrogen. In some embodiments, each R¹ is hydrogen and each R³-R⁷ is hydrogen.

In some embodiments, the present disclosure includes forming a cyclopentadienylide tin(II) compound of formula (II). In some embodiments, each R¹ is independently hydrogen, a C₁-C₄, or a halide containing C₁-C₄ group.

In some embodiments, the cyclopentadienylide (Cp) has the formula (1). In some embodiments, R³-R⁷ is hydrogen or C₁-C₄. In some embodiments, the method 200 includes forming a cyclopentadienylide tin(II) compound of formula (II) by contacting [Sn(O(R¹))₂]₂ with Cp₂Sn. In some embodiments, the method 200 includes dissolving [Sn(O(R¹))₂]₂ in tetrahydrofuran (THF) before the contacting step. In some embodiments, the method 200 includes dissolving Cp₂Sn in tetrahydrofuran (THF) before the contacting step.

### EXAMPLES

### Example 1

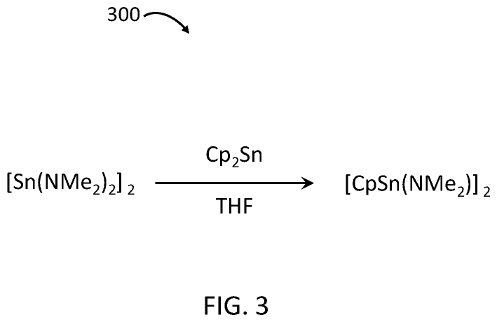

FIG. 3 depicts a non-limiting example of a method 300 for the synthesis of cyclopentadienyl tin(II) amides using Cp₂Sn described herein.

[Sn(N(CH₃)₂)₂]₂ (1.0 g, 3.98 mmol) was loaded into an amber 40 mL vial and dissolved in tetrahydrofuran (10 mL). Cp₂Sn was loaded into a separate amber 40 mL vial equipped with a magnetic stir bar and dissolved in THF (10 mL). The [Sn(N(CH₃)₂)₂]₂ solution was added to the Cp₂Sn solution with stirring over the course of five minutes. The resulting pale-yellow solution was stirred overnight at roam temperature. The next day the pale-yellow solution was dried under reduced pressure to yield [CpSn(N(CH₃)₂)]₂ as an off-white/yellow solid (Mass: 1.63 g, Yield: 89.5%). X-ray quality crystals were grown by slow evaporation of a concentrated C₆D₆ solution. ¹H-NMR (400 MHz, d₈-THF, 298K): 2.65 (s, 6H); 2.73 (s, 6H); 6.12 (s, 10H) ppm; ¹³C{¹H}-NMR (100 MHz, d₈-THF, 298K): 44.06 ppm; ¹¹⁹Sn{¹H}-NMR (149 MHz, d₈-THF, 298K): −287.3, −306.12 ppm.

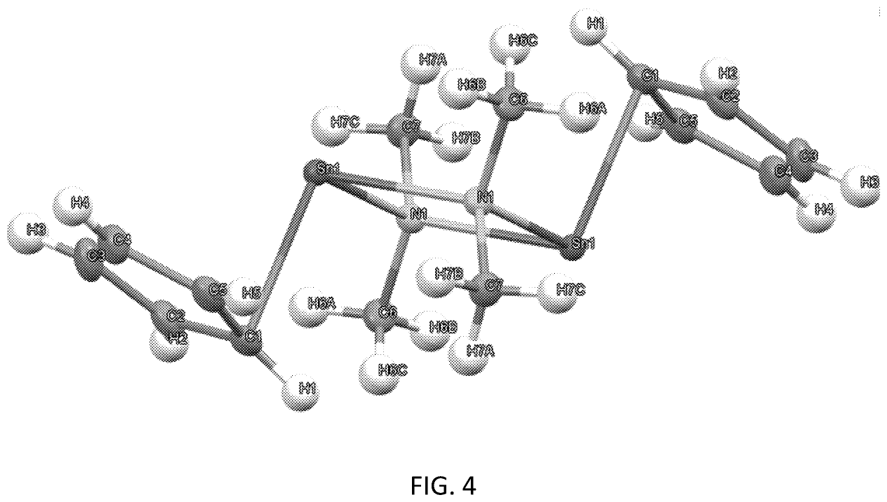

FIG. 4 depicts a solid-state structure of [CpSn(N(CH₃)₂)]₂ as determined by X-ray crystallographic analysis.

| | |
|---|---|
| Empirical formula | C20 H22 D6 N2 Sn2 |
| Molecular formula | C14 H22 N2 Sn2, C6 D6 |
| Formula weight | 539.86 |
| Temperature | 100.00 K |
| Wavelength | 0.71073 Å |
| Crystal system | Triclinic |
| Space group | P-1 |
| Unit cell dimensions | a = 5.7015 (2) Å; α = 109.2680(10)° |
| | b = 8.8255 (2) Å; β = 90.5790(10)° |
| | c = 11.3321 (3) Å; γ = 106.5100(10)° |
| Volume | 512.67(3) Å³ |
| Z | 1 |
| Density (calculated) | 1.749 Mg/m³ |
| Absorption coefficient | 2.440 mm⁻¹ |
| F(000) | 262 |
| Crystal size | 0.18 × 0.16 × 0.11 mm³ |
| Crystal color, habit | colorless block |
| Theta range for data | 2.567 to 26.365° |
| collection | |
| Index ranges | −7 <= h <= 7, −11 <= k <= |
| | 11, −14 <= l <= 14 |
| Reflections collected | 16961 |
| Independent reflections | 2079 [R(int) = 0.0308] |
| Completeness to theta = | 99.9% |
| 25.242° | |
| Absorption correction | None |
| Max. and min. transmission | 0.2607 and 0.2204 |
| Refinement method | Full-matrix least-squares on F² |
| Data/restraints/parameters | 2079/0/115 |
| Goodness-of-fit on F² | 1.119 |
| Final R indices [I > | R1 = 0.0107, wR2 = 0.0267 |
| 2sigma(I)] | |
| R indices (all data) | R1 = 0.0109, wR2 = 0.0268 |
| Extinction coefficient | 0.0049(8) |
| Largest diff. peak and hole | 0.315 and −0.280 e.Å⁻³ |

### Example 2

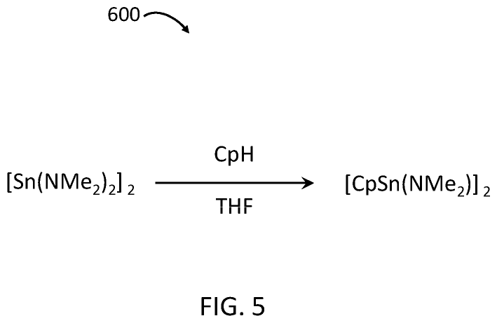

FIG. 5 depicts a non-limiting example of a method 600 for the synthesis of cyclopentadienyl tin(II) amides using CpH described herein.

Cyclopentadiene (0.158 g, 2.40 mmol) was diluted with 3 mL of tetrahydrofuran and added dropwise over the course of five minutes to a stirred 3 mL THF solution of [Sn(N(CH₃)₂)₂]₂ (0.500 g, 1.20 mmol) and the resulting pale-yellow solution stirred overnight. The next day the volatiles were removed under reduced pressure to yield [CpSn(N(CH₃)₂)]₂ as a pale-yellow solid. ¹H-, ¹³C-, and ¹¹⁹Sn-NMR collected on a d₈-THF solution of the product are consistent with that obtained by combining Cp₂Sn and [Sn(N(CH₃)₂)₂]₂.

### Aspects

Various Aspects are described below. It is to be understood that any one or more of the features recited in the following Aspect(s) can be combined with any one or more other Aspect(s).

Aspect 1. A cyclopentadienylide tin(II) compound of formula (I) comprising:

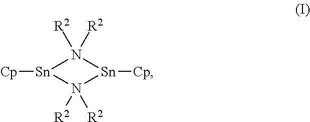

wherein each R² is independently hydrogen, a C₁-C₄, or a halide containing C₁-C₄,
wherein

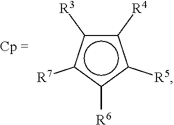

and
wherein R³-R⁷ is hydrogen or C₁-C₄.

Aspect 2. The compound of Aspect 1, wherein each R² is independently a methyl, ethyl, propyl, isopropyl, n-butyl, isobutyl, t-butyl, or sec-butyl group.

Aspect 3. The compound of Aspect 1, wherein each R² is a methyl group.

Aspect 4. The compound of Aspect 1, wherein each R² is a C₁-C₄ alkyl group.

Aspect 5. The compound as in any one of the preceding Aspects, wherein the C₁-C₄ is branched or unbranched.

Aspect 6. The compound as in any one of the preceding Aspects, wherein the C₁-C₄ is substituted or unsubstituted.

Aspect 7. The compound as in any one of the preceding Aspects, wherein each R³-R⁷ is hydrogen.

Aspect 8. The compound of Aspect 1, wherein each R² is hydrogen and each R³-R⁷ is hydrogen.

Aspect 9. A method of forming a cyclopentadienylide tin(II) compound of formula (I):

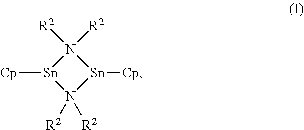

wherein each R² is independently hydrogen, a C₁-C₄, or a halide containing C₁-C₄ group,
wherein

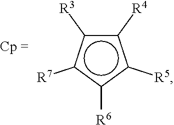

wherein R³-R⁷ is hydrogen or C₁-C₄, and
wherein the method comprises: contacting [Sn(N(R²)₂)₂]₂ with Cp₂Sn or CpH.

Aspect 10. The method of Aspect 9, wherein [Sn(N(R²)₂)₂]₂ is dissolved in tetrahydrofuran before the contacting step.

Aspect 11. The method of Aspect 9 or Aspect 10, wherein R² is independently a methyl, ethyl, propyl, isopropyl, n-butyl, isobutyl, t-butyl, or sec-butyl group.

Aspect 12. The method as in one of Aspects 9-11, wherein Cp₂Sn or CpH is dissolved in tetrahydrofuran before the contacting step.

Aspect 13. A cyclopentadienylide tin(II) compound of formula (II):

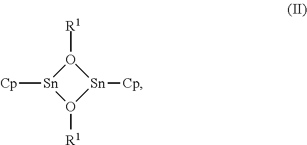

wherein each R¹ is independently hydrogen, C₁-C₄, or a halide containing C₁-C₄, and
wherein

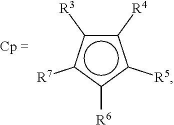

and
wherein R³-R⁷ is hydrogen or C₁-C₄.

Aspect 14. The compound of Aspect 13, wherein each R¹ is independently a methyl, ethyl, propyl, isopropyl, n-butyl, isobutyl, t-butyl, or sec-butyl group.

Aspect 15. The compound of Aspect 13, wherein each R¹ is a methyl group.

Aspect 16. The compound of Aspect 13, wherein each R¹ is a C₁-C₄ alkyl group.

Aspect 17. The compound as in any one of the preceding Aspects, wherein the C₁-C₄ is branched or unbranched.

Aspect 18. The compound as in any one of the preceding Aspects, wherein the C₁-C₄ is substituted or unsubstituted.

Aspect 19. The compound as in any one of the preceding Aspects, wherein each R³-R⁷ is hydrogen.

Aspect 20. The compound of Aspect 13, wherein each R¹ is hydrogen and each R³-R⁷ is hydrogen.

Aspect 21. A method of forming a cyclopentadienylide tin(II) compound of formula (II):

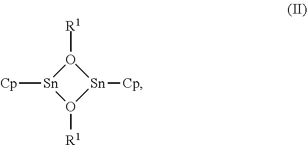

wherein each R¹ is independently hydrogen, a C₁-C₄, or a halide containing C₁-C₄ group,
wherein

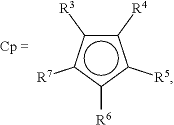

wherein R³-R⁷ is hydrogen or C₁-C₄, and wherein the method comprises:
contacting [Sn(O(R¹))₂]₂ with Cp₂Sn.

Aspect 22. The method of Aspect 21, wherein [Sn(O(R¹))₂]₂ is dissolved in tetrahydrofuran before the contacting step.

Aspect 23. The method of Aspect 21 or Aspect 22, wherein R¹ is independently a methyl, ethyl, propyl, isopropyl, n-butyl, isobutyl, t-butyl, or sec-butyl group.

Aspect 24. The method as in one of Aspects 21-23, wherein Cp₂Sn is dissolved in tetrahydrofuran before the contacting step.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A cyclopentadienylide tin(II) compound of formula (II): 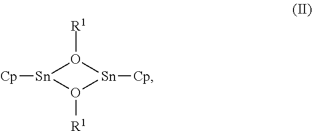
wherein each R¹ is independently hydrogen, C₁-C₄, or a halide containing C₁-C₄, and
wherein 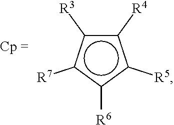
and
wherein R³-R⁷ is hydrogen or C₁-C₄.

2. The compound of claim 1, wherein each R¹ is independently a methyl, ethyl, propyl, isopropyl, n-butyl, isobutyl, t-butyl, or sec-butyl group.

3. The compound of claim 1, wherein each R¹ is a methyl group.

4. The compound of claim 1, wherein each R¹ is a C₁-C₄ alkyl group.

5. The compound of claim 1, wherein each R³-R⁷ is hydrogen.

6. The compound of claim 1, wherein each R¹ is hydrogen and each R³-R⁷ is hydrogen.

7. A method of forming a cyclopentadienylide tin(II) compound of formula (II): 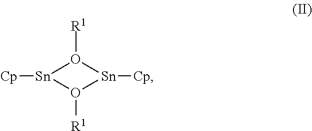
wherein each R¹ is independently hydrogen, a C₁-C₄, or a halide containing C₁-C₄ group,
wherein 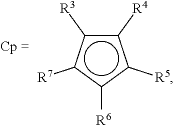
wherein R³-R⁷ is hydrogen or C₁-C₄, and wherein the method comprises:
contacting [Sn(O(R¹))₂]₂ with Cp₂Sn.

8. The method of claim 7, wherein [Sn(O(R¹))₂]₂ is dissolved in tetrahydrofuran before the contacting step.
